(19) United States
(12) Patent Application Publication
(10) Pub. No.: US 2018/0244294 A1
(43) Pub. Date: Aug. 30, 2018

(54) CARRIAGE

(71) Applicant: NABTESCO CORPORATION, Tokyo (JP)

(72) Inventors: Osamu OCHIAI, Tsu-shi (JP); Yudai MITSUMORI, Tsu-shi (JP); Kenya TOMIYASU, Tsu-shi (JP)

(21) Appl. No.: 15/902,273

(22) Filed: Feb. 22, 2018

(30) Foreign Application Priority Data
Feb. 27, 2017 (JP) 2017-035509

(51) Int. Cl. B62B 5/00; B62B 5/06

(52) U.S. Cl. CPC B62B 5/0073; B62B 5/003; B62B 5/068; B62B 5/0083; B62B 5/004

(57) ABSTRACT

A carriage has a carriage body having a loading platform for bearing a load and a plurality of wheels rotatably retained to the loading platform, an operation handle connected to the carriage body and grasped by a user operating the carriage, a sensor for measuring information related to a force applied to the operation handle, and a driving device for outputting a driving force based on a result of detection by the sensor to any of the plurality of wheels.

### CROSS-REFERENCE TO RELATED APPLICATIONS

This application is based on and claims the benefit of priority from Japanese Patent Application Serial No. 2017-035509 (filed on Feb. 27, 2017), the contents of which are hereby incorporated by reference in their entirety.

### TECHNICAL FIELD

The present invention relates to a carriage used to convey a load.

### BACKGROUND

For example, a carriage disclosed in Japanese Patent Application Publication No. 2016-117420 is assisted in traveling by use of a driving force from a drive source such as a motor. In this carriage, a handle for steering a steering wheel is provided with a switch for controlling an output of the driving force. Thus, an operator can operate the switch with the same hand that grips the handle so as to adjust an output of the driving force.

It cannot be said, however, that operating the switch at every time of adjusting an output of a driving force provides excellent operability. Furthermore, due to such poor operability, it is also assumed that a driving force is always kept outputted regardless of a traveling environment. Specifically, it is also expected that even after the carriage has completed climbing a slope or after the carriage has got over a step height, a driving force is left being outputted due to troublesomeness of operating the switch, which is not preferable also from the viewpoint of energy saving.

### SUMMARY

The present invention has been made in view of the foregoing, and an object of the present invention is to improve operability of a carriage assisted in traveling by being supplied with a driving force. A carriage according to the present invention is provided with carriage body having a loading platform for bearing a load and a plurality of wheels rotatably retained to the loading platform, an operation handle connected to the carriage body and grasped by a user operating the carriage, a sensor for measuring information related to a force applied to the operation handle, and a driving device for outputting a driving force based on a result of detection by the sensor to any of the plurality of wheels.

In the carriage according to the present invention, a configuration may be adopted in which the sensor includes a first sensor and a second sensor, the driving device includes a first driving device and a second driving device, the plurality of wheels include a first wheel and a second wheel spaced apart from each other in a width direction of the carriage, the first driving device outputs a driving force based on a result of measurement by the first sensor to the first wheel, and the second driving device outputs a driving force based on a result of measurement by the second sensor to the second wheel.

In the carriage according to the present invention, a configuration may be adopted in which the operation handle has a handle member and an operation grip member, the handle member extending out from the carriage body, the operation grip member being supported to the handle member, the operation grip member includes a first grip portion and a second grip portion spaced apart from each other in a width direction of the carriage and each grasped by a user, the sensor includes a first sensor and a second sensor, the first sensor detecting a movement of the first grip portion relative to the handle member, the second sensor detecting a movement of the second grip portion relative to the handle member, the driving device includes a first driving device and a second driving device, the plurality of wheels include a first wheel and a second wheel spaced apart from each other in the width direction of the carriage, the first driving device outputs a driving force based on a result of measurement by the first sensor to the first wheel, and the second driving device outputs a driving force based on a result of measurement by the second sensor to the second wheel.

In the carriage according to the present invention, the operation grip member may be divided into a first operation grip member including the first grip portion and a second operation grip member including the second grip portion.

In the carriage according to the present invention, a configuration may be adopted in which the operation handle includes a first handle member, a second handle member, and an operation grip member, the first handle member and the second handle member extending upward from the carriage body obliquely in a front-rear direction of the carriage, the operation grip member being connected to the first handle member and the second handle member and grasped by a user at a position spaced from the carriage body, the first handle member and the second handle member are spaced apart from each other in a width direction of the carriage, the sensor includes a first sensor and a second sensor, the first sensor measuring information related to a force applied in a longitudinal direction of the first handle member, the second sensor measuring information related to a force applied in a longitudinal direction of the second handle member, the driving device includes a first driving device and a second driving device, the plurality of wheels include a first wheel and a second wheel spaced apart from each other in the width direction of the carriage, the first driving device outputs a driving force based on a result of measurement by the first sensor to the first wheel, and the second driving device outputs a driving force based on a result of measurement by the second sensor to the second wheel.

In the carriage according to the present invention, the sensor may detect a swing movement of the operation handle extending upward from the carriage body.

In the carriage according to the present invention, a configuration may be adopted in which the operation handle is swingable with respect to the carriage body, the operation handle includes a first grip portion and a second grip portion spaced apart from each other in a width direction of the carriage and each grasped by a user, the sensor includes a first sensor and a second sensor, the first sensor detecting a swing movement of a part of the operation handle, the part including the first grip portion, the second sensor detecting a swing movement of another part of the operation handle, the another part including the second grip portion, the driving device includes a first driving device and a second driving device, the plurality of wheels include a first wheel and a second wheel spaced apart from each other in the width direction of the carriage, the first driving device outputs a driving force based on a result of measurement by the first sensor to the first wheel, and the second driving device outputs a driving force based on a result of measurement by the second sensor to the second wheel.

In the carriage according to the present invention, the operation handle may be divided into a first operation handle including the first grip portion and a second operation handle including the second grip portion.

In the carriage according to the present invention, a configuration may be adopted in which the carriage further includes a first frame member and a second frame member spaced apart from each other in a width direction of the carriage and each extending upward from the carriage body, the operation handle has a first operation handle and a second operation handle spaced apart from each other in the width direction of the carriage and each being swingable with respect to the carriage body, a first joint member is provided to join the first frame member to the first operation handle, and a second joint member is provided to join the second frame member to the second operation handle, the sensor includes a first sensor and a second sensor, the first sensor measuring information related to a force applied in a longitudinal direction of the first joint member, the second sensor measuring information related to a force applied in a longitudinal direction of the second joint member, the driving device includes a first driving device and a second driving device, the plurality of wheels include a first wheel and a second wheel spaced apart from each other in the width direction of the carriage, the first driving device outputs a driving force based on a result of measurement by the first sensor to the first wheel, and the second driving device outputs a driving force based on a result of measurement by the second sensor to the second wheel.

In the carriage according to the present invention, a configuration may be adopted in which the operation handle has a handle member and an operation input member, the handle member extending out from the carriage body, the operation input member being provided on the handle member, the operation input member includes a base portion and a grip portion, the base portion being connected to the handle member, the grip portion being movably retained to the base portion and grasped by a user, and the sensor detects a movement of the grip portion relative to the base portion.

In the carriage according to the present invention, the grip portion may be movable in a front-rear direction of the carriage relative to the base portion.

In the carriage according to the present invention, a position of the operation input member mounted on the handle member is changeable.

According to the present invention, it is possible to improve operability of a carriage assisted in traveling by being supplied with a driving force.

### BRIEF DESCRIPTION OF THE DRAWINGS

FIG. 1 is a perspective view for explaining one embodiment of the present invention, showing a carriage according to a first example.

FIG. 2 is a plan view showing the carriage in FIG. 1 from below.

FIG. 3 is a block diagram related to control of a driving force.

FIG. 4 is a view showing a sensor in the carriage.

FIG. 5a is a view for explaining an action of the carriage shown in FIG. 1.

FIG. 5b is a view for explaining an action of the carriage shown in FIG. 1.

FIG. 5c is a view for explaining an action of the carriage shown in FIG. 1.

FIG. 5d is a view for explaining an action of the carriage shown in FIG. 1.

FIG. 6 is a perspective view showing a carriage according to a second example.

FIG. 7 is a view showing the carriage in FIG. 6 from behind.

FIG. 8a is a view for explaining an action of the carriage shown in FIG. 6.

FIG. 8b is a view for explaining an action of the carriage shown in FIG. 6.

FIG. 8c is a view for explaining an action of the carriage shown in FIG. 6.

FIG. 8d is a view for explaining an action of the carriage shown in FIG. 6.

FIG. 9 is a perspective view showing a carriage according to a third example.

FIG. 10 is a view showing the carriage in FIG. 9 from sideways.

FIG. 11 is a view showing the carriage in FIG. 9 from behind FIG. 12 is a perspective view showing a carriage according to a fourth example.

FIG. 13 is a view showing the carriage in FIG. 12 from sideways.

FIG. 14 is a perspective view showing a carriage according to a fifth example.

FIG. 15 is an enlarged view showing an operation input member in the carriage shown in FIG. 14.

FIG. 16 is an enlarged view showing one modification example of the operation input member in the carriage according to the fifth example.

### DESCRIPTION OF THE PREFERRED EMBODIMENTS

One embodiment of the present invention will now be described with reference to the appended drawings. In the drawings appended hereto, scales, aspect ratios, and so on have been appropriately altered from their actual values for emphasis so as to facilitate illustration and understanding of the drawings.

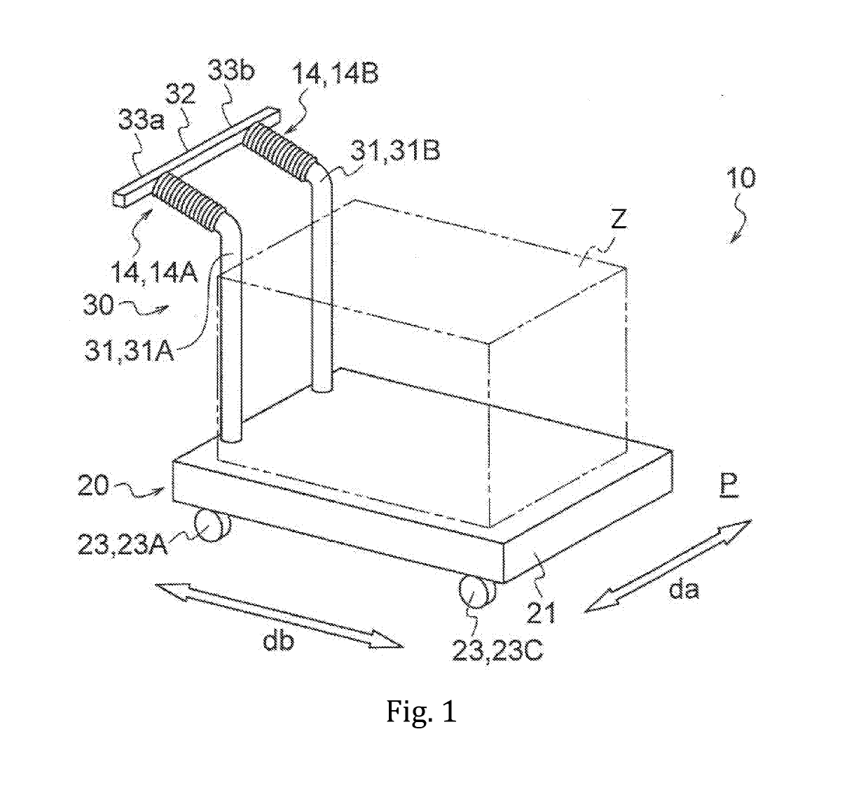

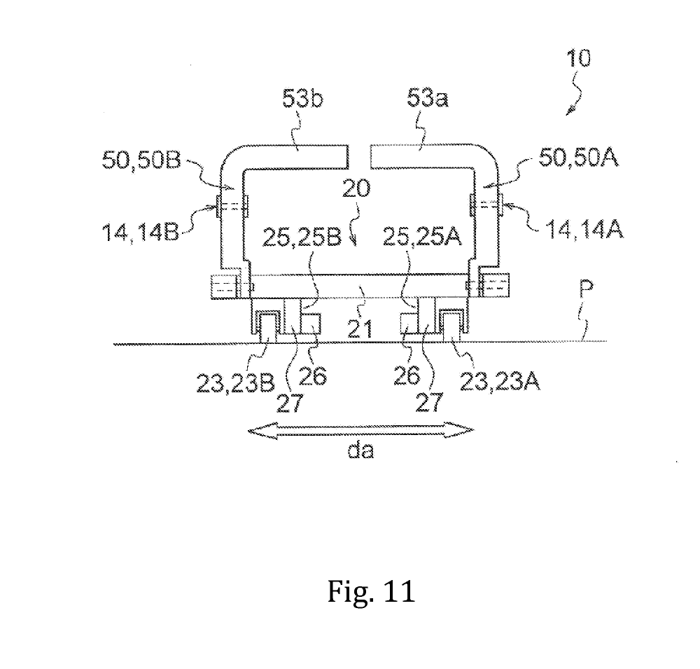

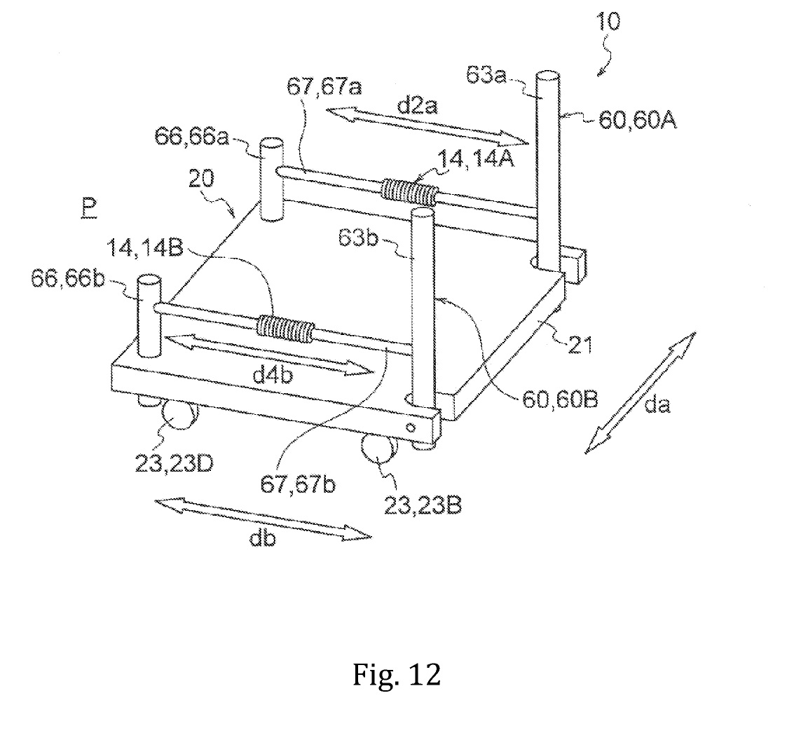

FIG. 1 to FIG. 16 are views for explaining one embodiment of the present invention. In one embodiment described below, a carriage 10 is a device used to convey a load Z. The carriage 10 has a carriage body 20 having a wheel 23 and any one of operation handles 30, 40, 50, 60, and 70 grasped by a user (an operator) operating the carriage 10. In the carriage 10, a driving force is outputted from a driving device 25 to the wheel 23 so as to assist the carriage 10 in traveling by being pushed by the user (the operator).

Particularly, the carriage 10 described in this embodiment is designed with some thought to improve operability. To be more specific, without entailing intentionally operating a switch or the like, a driving force for assisting the carriage 10 in traveling is outputted based on a traveling state of the carriage 10, a force applied by the user, or the like. In a specific configuration, the carriage 10 has a sensor 14 for measuring information related to a force applied to each of the operation handles 30, 40, 50, 60, and 70 and a control portion 12 for controlling the driving device 25 based on a result of detection by the sensor 14. With reference to the appended drawings, the following describes some specific examples of the carriage 10. Between some specific examples described below, the carriage body 20, the driving device 25, or the like can be configured the same way. In the plurality of specific examples of the carriage 10 described below, components that can be configured the same way are denoted by a common reference character, and a duplicate detailed description thereof is omitted.

### First Example

With reference to FIG. 1 to FIGS. 5a to 5d, a description is given of a first example of the carriage 10. First, the description is directed to the carriage body 20 and the operation handle 30 of the carriage 10. The carriage body 20 has a loading platform 21 and a plurality of wheels 23 rotatably retained to the platform 21. As shown in FIG. 1, the loading platform 21 is where the load Z is to be loaded. In an example shown, the loading platform 21 is a plate-shaped member and has a rectangular shape in plan view. The loading platform 21, however, may be a box-shaped member having a bottom plate, a side wall, and so on or may be a basket-shaped member having a bottom plate and a side frame.

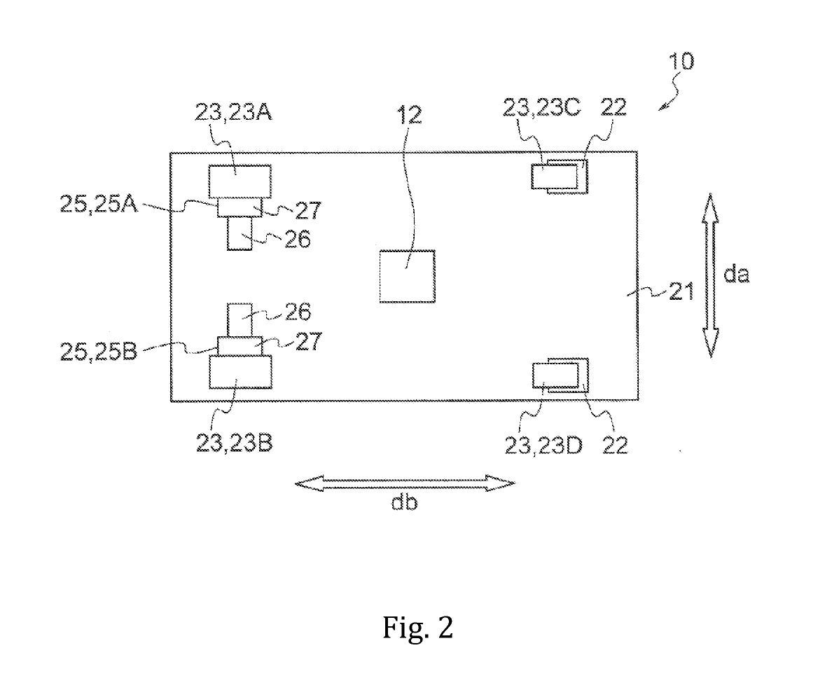

In the example shown, the loading platform 21 rotatably retains the four wheels 23. As shown in FIG. 2, the carriage body 20 shown has a first wheel 23A constituting a right-side rear wheel, a second wheel 23B constituting a left-side rear wheel, a third wheel 23C constituting a right-side front wheel, and a fourth wheel 23D constituting a left-side front wheel. The first wheel 23A and the second wheel 23B are spaced apart from each other in a width direction da of the carriage 10. The third wheel 23C and the fourth wheel 23D are also spaced apart from each other in the width direction da of the carriage 10. Furthermore, the first wheel 23A and the third wheel 23C are spaced apart from each other in a front-rear direction (a traveling direction) db of the carriage 10. The second wheel 23B and the fourth wheel 23D are also spaced apart from each other in the front-rear direction db of the carriage 10.

In the example shown, the first wheel 23A and the second wheel 23B are rotatably retained to the carriage body 20. A rotation axis of each of the first wheel 23A and the second wheel 23B is substantially parallel to the width direction da of the carriage 10 and substantially perpendicular to the front-rear direction db of the carriage 10. On the other hand, each of the third wheel 23C and the fourth wheel 23D is retained to the loading platform 21 via a caster mechanism 22. The caster mechanism 22 is mounted to the loading platform 21. The caster mechanism 22 retains each of these wheels 23 rotatably about a rotation axis of the each of these wheels 23 and retains the each of these wheels 23 swivelably about a caster axis substantially perpendicular to the rotation axis thereof.

A configuration of the carriage body 20 shown is only illustrative. For example, the number of the wheels 23 is not limited to four and may be three or five or more. As one specific example, the carriage body 20 may be configured to have a pair of rear wheels and one front wheel. Furthermore, while in the example shown, the loading platform 21 has a rectangular shape in plan view, there is no limitation thereto. The loading platform 21 can adopt various configurations that can rotatably retain the wheels 23.

The operation handle 30 is a portion grasped by a user (an operator) operating the carriage 10. That is, the user applies, via the operation handle 30, a force for causing the carriage 10 to travel.

In a first example, the operation handle 30 extends upward from the carriage body 20. Further, the after-mentioned sensor 14 is built in the operation handle 30. As shown in FIG. 1, the operation handle 30 has a handle member 31 extending out from the carriage body 20 and an operation grip member 32 supported to the handle member 31. The handle member 31 has a first handle member 31A and a second handle member 31B spaced apart from each other in the carriage width direction da. In the first example of the carriage 10, the first handle member 31A and the second handle member 31B are disposed parallel to each other and extend in a direction substantially perpendicular to a travel surface P. The operation grip member 32 is a portion to be grasped by a user. The operation grip member 32 shown extends in a horizontal direction over such a range as to face both of the first handle member 31A and the second handle member 31B. The operation grip member 32 includes a first grip portion 33a and a second grip portion 33b spaced apart from each other in the width direction da of the carriage 10. In usual use of the carriage 10, a user grasps the first grip portion 33a with his/her right hand and the second grip portion 33b with his/her left hand.

The operation handle 30 shown in FIG. 1 is merely one example and can be variously modified. For example, in addition to the first handle member 31A and the second handle member 31B, the handle member 31 may have a joint portion joining together respective upper ends of the first handle member 31A and the second handle member 31B. In this example, the joint portion may extend along the operation grip member 32 so as to face the operation grip member 32.

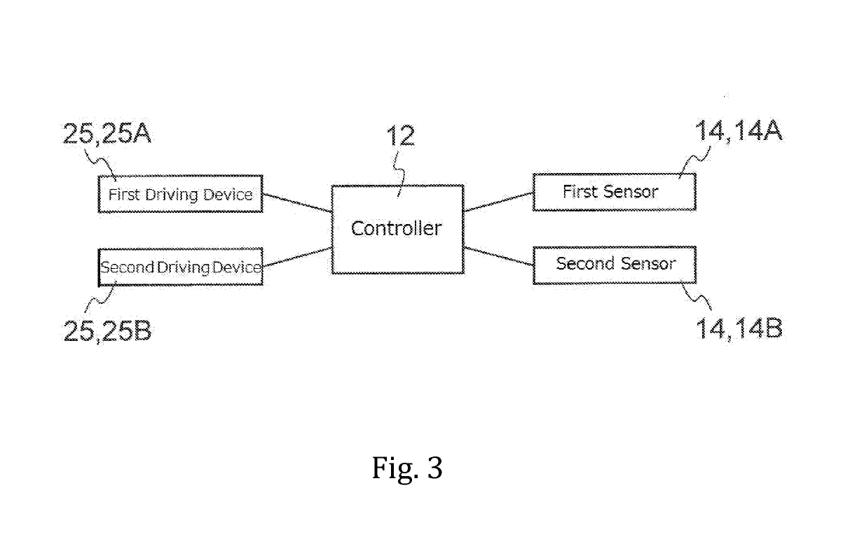

Next, a description is given of the driving device 25, the sensor 14, and the control portion 12. As shown in FIG. 3, the control portion 12 is electrically connected to the driving device 25 and to the sensor 14. As mentioned above, the sensor 14 measures information related to a force applied to the operation handle 30. The control portion 12 controls the driving device 25 based on a result of detection by the sensor 14. The driving device 25 outputs a driving force based on the result of detection by the sensor 14 to any of the wheels 23. The carriage 10 is provided with an unshown battery, and thus the driving device 25 can operate by being supplied with power from this battery. Similarly to the control portion 12 shown in FIG. 2, for example, the battery is supported by the loading platform 21.

As shown in FIG. 1, in the first example of the carriage 10 shown, the sensor 14 includes a first sensor 14A and a second sensor 14B spaced apart from each other in the width direction da of the carriage body 20. Furthermore, as shown in FIG. 2, in the first example of the carriage 10 shown, the driving device 25 includes a first driving device 25A and a second driving device 25B. The first driving device 25A outputs a driving force based on a result of detection by the first sensor 14A to the first wheel 23A. The second driving device 25B outputs a driving force based on a result of detection by the second sensor 14B to the second wheel 23B.

Each of the driving devices 25 has, as one example, a drive source 26 and a speed reducer 27. As the drive source 26, for example, a motor or an engine can be used. The speed reducer 27 reduces a speed of rotation outputted from the drive source 26 so that an increased torque is obtained, and outputs the rotation with the increased torque to a corresponding one of the wheels 23. As the speed reducer 27, for example, an eccentric oscillating speed reducer, a speed reducer using a planetary gear, or a combination of these can be used. The driving device 25 may be configured without including the speed reducer 27. Furthermore, the driving device 25 may include another mechanism such as a clutch capable of switching between transmission and shutoff of rotational power.

Next, a description is given of the sensor 14 for measuring information related to a force applied to the operation handle 30. As a force monitored by the sensor 14, for example, a translational force or a rotational force such as a moment or a torque can be used. As the sensor 14 enabling detection of such an index, a sensor for detecting a force, such as a torque sensor, a displacement sensor, a speed sensor, an acceleration sensor, or the like can be used. By using such a sensor for detecting a force, such as a torque sensor, as the sensor 14, a force applied to the operation handle 30 can be directly evaluated. Furthermore, by performing an arithmetic operation on an output from any of such a displacement sensor, a speed sensor, and an acceleration sensor, a magnitude of a force such as a translational force, a rotational force, or the like applied to the operation handle 30 can also be evaluated. Thus, the sensor 14 may sense, as information related to a force applied to the operation handle 30, a position, a movement, a speed, an acceleration, or the like of the operation handle 30.

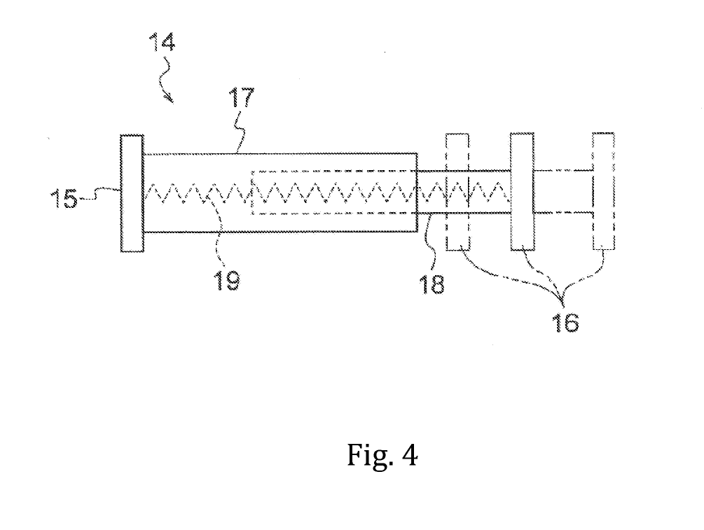

FIG. 4 shows one specific example of the sensor 14. The sensor 14 shown in FIG. 4 is a slide-type switch constituting a displacement sensor. The sensor 14 is configured to be expandable and contractible and acquires information related to an expansion amount and a contraction amount. The sensor 14 configured as above can highly accurately evaluate a translational force toward a predetermined direction, and the sensor 14 itself is simply configured and less costly. Moreover, it is also easy to perform, for example, arithmetic processing on a result of measurement.

The sensor 14 shown in FIG. 4 has a first component 17 and a second component 18 movable relative to each other in one direction. The first component 17 and the second component 18 are both formed of a cylindrical member. The first component 17 has a diameter larger than that of the second component 18, and part of the second component 18 is inserted into the first component 17. Furthermore, a biasing member 19 is provided in the first component 17 and the second component 18. The biasing member 19 is providing a bias so that the first component 17 and the second component 18 are positioned at a reference position. In a case where a combined body of the first component 17 and the second component 18 is in an expanded state, the biasing member 19 provides a bias so that the first component 17 and the second component 18 are brought close to each other. On the other hand, in a case where the combined body of the first component 17 and the second component 18 is in a contracted state, the biasing member 19 provides a bias so that the first component 17 and the second component 18 are separated from each other. The sensor 14 further has a first sensor base 15 used to mount the first component 17 to one of the handle member 31 and the operation grip member 32 and a second sensor base 16 used to mount the second component 18 to the other of the handle member 31 and the operation grip member 32.

The sensor 14 is capable of measuring a relative position between the first component 17 and the second component 18. For example, similarly to a so-called potentiometer, the sensor 14 may have a configuration capable of detecting a relative movement between the first component 17 and the second component 18 along an axial direction (a longitudinal direction) of the combined body of the first component 17 and the second component 18. As another example, the sensor 14 may have a configuration capable of measuring a total length of the combined body of the first component 17 and the second component 18 along the axial direction (the longitudinal direction) thereof. As still another example, the sensor 14 may have a configuration capable of measuring a separation distance between the first sensor base 15 and the second sensor base 16 or a separation length between the first sensor base 15 and the second sensor base 16 along the front-rear direction db. A measurement mechanism of the sensor 14 for actually performing measurement is not particularly limited and can take various forms such as a resistive type, a photoelectric type, a magnetic type, and so on.

In a specific application example, the first sensor base 15 secures the first component 17 in the front-rear direction db with respect to the operation grip member 32. The second sensor base 16 secures the second component 18 in the front-rear direction db with respect to the handle member 31. Thus, in a case where the operation grip member 32 is pushed or pulled with respect to the handle member 31, the first component 17 and the second component 18 move relative to each other in the axial direction (the longitudinal direction) thereof. When consideration is given to stability at the time of operating the carriage 10, preferably, an allowable relative movement amount between the first component 17 and the second component 18 is set to be reduced to such an extent that a force applied to the operation handle 30 can still be measurable.

In the example shown in FIG. 1, the first sensor 14A and the second sensor 14B are spaced apart from each other in the carriage width direction da. More specifically, the first sensor 14A is provided between the first grip portion 33a and the first handle member 31A, and the second sensor 14B is provided between the second grip portion 33b and the second handle member 31B. Further, in order to enable a movement of the operation grip member 32 at the time of an after-mentioned swiveling movement of the carriage 10, the first sensor base 15 of each of the sensors 14A and 14B is used to swivelably mount the first component 17 to one of the handle member 31 and the operation grip member 32, and the second sensor base 16 of the each of the sensors 14A and 14B is used to swivelably mount the second component 18 to the other of the handle member 31 and the operation grip member 32.

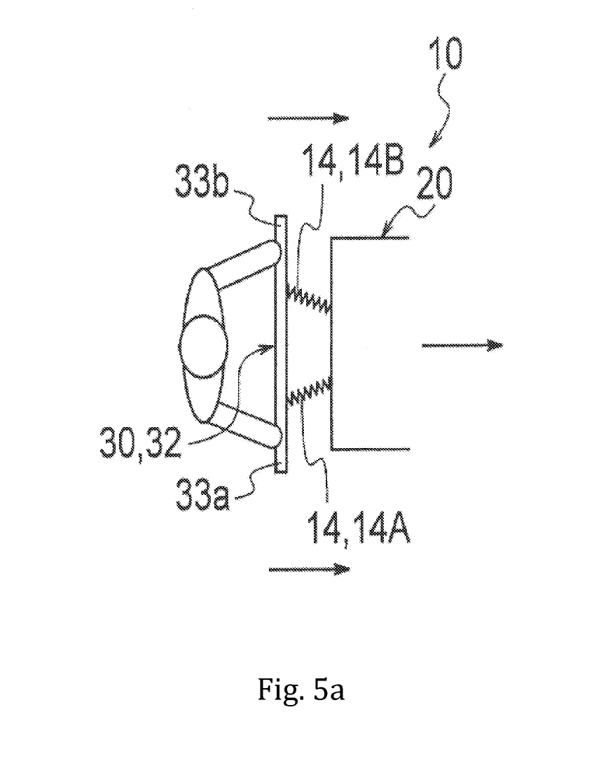

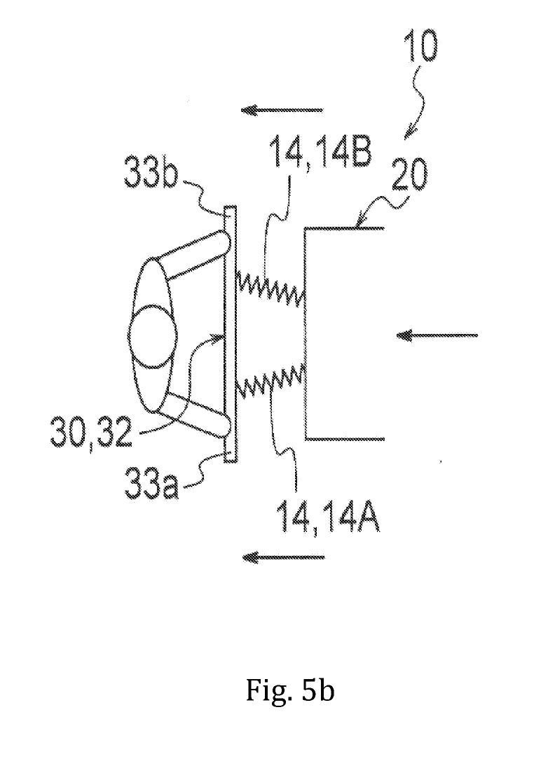

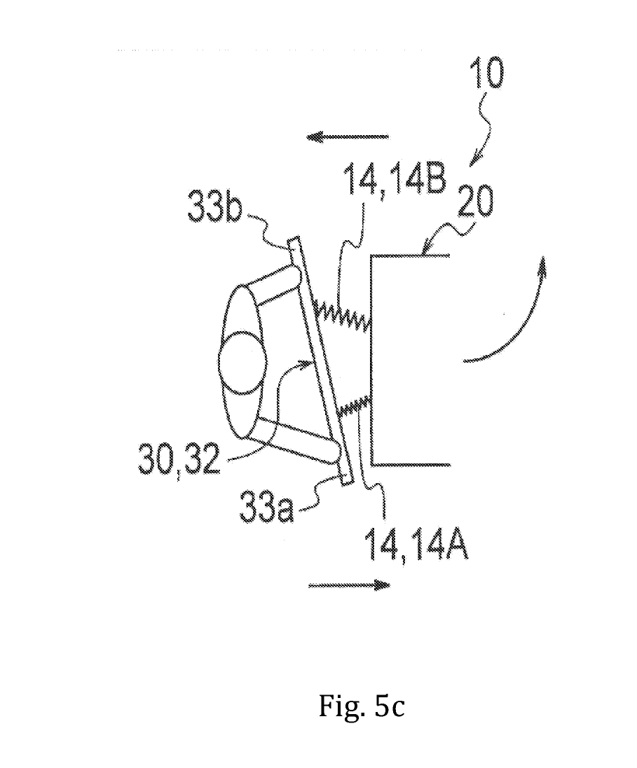

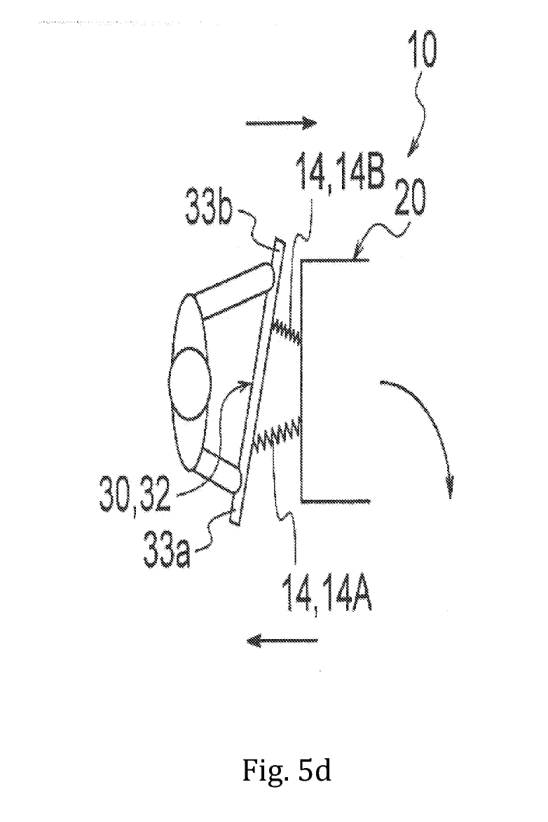

The control portion 12 performs an arithmetic operation on an output result from the sensor 14 and, based on a result of the arithmetic operation, adjusts a driving force outputted from the driving device 25 to a corresponding one of the wheels 23. As shown in FIG. 4 and FIGS. 5a to 5d, in a case where one of the slide-type sensors 14 shown is contracted in the axial direction (the longitudinal direction, a sliding direction) thereof against a biasing force of the biasing member 19, that is, in a case where the first component 17 and the second component 18 are brought close to each other, one of the driving devices 25 corresponding to said one of the slide-type sensors 14 outputs a driving force for causing forward travel to a corresponding one of the wheels 23. The driving force for causing forward travel increases with increasing contraction amount of the sensor 14. Conversely, in a case where one of the slide-type sensors 14 is expanded in the axial direction (the longitudinal direction, the sliding direction) thereof against a biasing force of the biasing member 19, that is, in a case where the first component 17 and the second component 18 are separated from each other, one of the driving devices 25 corresponding to said one of the slide-type sensors 14 outputs a driving force for causing rearward travel to a corresponding one of the wheels 23. The driving force for causing rearward travel increases with increasing expansion amount of the sensor 14.

The term “forward (forward travel)” mentioned herein refers to a side toward the front wheels 23C and 23D in the front-rear direction, namely, in a direction perpendicular to the rotation axis of each of the rear wheels 23A and 23B, which are not casters (refers to traveling toward the front wheels 23C and 23D). On the other hand, the term “rearward (rearward travel)” refers to a side toward the rear wheels 23A and 23B in the front-rear direction (refers to traveling toward the rear wheels 23A and 23B).

Control of a driving force by the control portion 12, however, is not limited to the above-described example. For example, a configuration may be adopted in which the carriage body 20 includes other various sensors such as a contact sensor (a grip sensor) and a speed sensor, and outputs from these various sensors are also considered in controlling a driving force outputted from the driving device 25 to a corresponding one of the wheels 23.

Next, a description is given of a method for using the carriage 10 having the above-mentioned configuration.

As shown in FIG. 5a to FIG. 5d, a user grasps the operation grip member 32 of the operation handle 30 and pushes or pulls the operation handle 30 and thus can cause the carriage 10 to travel. At this time, the sensor 14 disposed between the handle member 31 and the operation grip member 32 measures a force applied to the operation handle 30. Depending on a situation where the load Z is heavy, the travel surface P is in a poor condition, or the travel surface P is an uphill slope, that is, when a force required to cause the carriage 10 to travel increases, a force applied to the operation handle 30 increases.

In a state shown in FIG. 5a, a user is grasping the first grip portion 33a and the second grip portion 33b of the operation handle 30 and pushing the carriage 10 forward in the front-rear direction. At this time, the first sensor 14A positioned between the first grip portion 33a and the first handle member 31A and the second sensor 14B positioned between the second grip portion 33b and the second handle member 31B are both deformed so that respective total lengths thereof are contracted along the axial direction thereof. Through this contraction, each of the sensors 14A and 14B detects that the carriage 10 is being pushed forward in the front-rear direction. The control portion 12 receives a result of detection by each of the sensors 14A and 14B and, based on the result of detection by the each of the sensors 14A and 14B, controls a corresponding one of the driving devices 25A and 25B to output a driving force for causing forward travel to a corresponding one of the wheels 23A and 23B. That is, a driving force is imparted as a force for assisting the user in pushing the carriage 10. In other words, a direct action itself of pushing the carriage 10 constitutes a condition for starting supply of a driving force. A driving force is generated without requiring that the user release his/her hand from the operation handle 30 in order to operate a switch or the like.

Furthermore, in the carriage 10, as a force required to cause the carriage 10 to travel increases, a deformation amount of the sensor 14 increases. Further, as a force required to cause the carriage 10 to travel increases, a driving force outputted to a corresponding one of the wheels 23 increases. That is, a magnitude of a force applied by the user to push the carriage 10 constitutes a condition for determining a magnitude of a driving force supplied to a corresponding one of the wheels 23. Thus, when there is a step height on the travel surface P, an operator applies an increased force so that the carriage 10 can get over said step height. At this time, the driving device 25 also supplies an increased driving force to a corresponding one of the wheels 23. Furthermore, after the carriage 10 has got over said step height, it becomes sufficient that the operator applies a decreased force thereto. At this time, a driving force outputted from the driving device 25 also becomes weaker. Thus, an unwanted output of a driving force is suppressed, so that, for example, useless consumption of a battery can be avoided. That is, energy saving can be achieved.

In a state shown in FIG. 5b, a user is grasping the first grip portion 33a and the second grip portion 33b of the operation handle 30 and pulling the carriage 10 rearward in the front-rear direction. At this time, each of the sensors 14A and 14B is deformed so that a total length thereof is expanded along the axial direction thereof. As a result, based on a result of detection by each of the sensors 14A and 14B, the control portion 12 controls a corresponding one of the driving devices 25A and 25B to output a driving force for causing rearward travel to a corresponding one of the wheels 23A and 23B. That is, also in this case, an appropriate driving force is imparted as a force for assisting the user in causing the carriage 10 to travel.

Furthermore, in the example shown, the sensor 14 includes the first sensor 14A and the second sensor 14B spaced apart from each other in the width direction da of the carriage body 20. The driving device 25 includes the first driving device 25A and the second driving device 25B, with respect to the first wheel 23A and the second wheel 23B spaced apart from each other in the width direction da of the carriage body 20, the first driving device 25A outputting a driving force based on a result of detection by the first sensor 14A to the first wheel 23A, and the second driving device 25B outputting a driving force based on a result of detection by the second sensor 14B to the second wheel 23B.

In a case where a user intends to cause the carriage 10 to swivel to the left, said user subconsciously and intuitively pushes the first grip portion 33a on a right rear side of the carriage 10 with an increased force and the second grip portion 33b on a left rear side of the carriage 10 with a decreased force. As a result, with respect to the first sensor 14A and the second sensor 14B spaced apart from each other in the carriage width direction da, a deformation amount of the first sensor 14A and a deformation amount of the second sensor 14B vary from each other. A contraction amount of the first sensor 14A receiving the stronger force and facing the first grip portion 33a increases, and a contraction amount of the second sensor 14B receiving the weaker force and facing the second grip portion 33b decreases. Thus, a driving force outputted from the first driving device 25A based on a deformation amount of the first sensor 14A increases, and a driving force outputted from the second driving device 25B based on a deformation amount of the second sensor 14B decreases. As a result, a driving force outputted from the driving device 25 also acts to cause the carriage 10 to swivel to the left. That is, in the carriage 10, based on a force applied to the carriage 10 so as to cause the carriage 10 to swivel, a driving force for causing the carriage 10 to swivel is supplied to a corresponding one of the wheels 23.

In a state shown in FIG. 5c, in an attempt to cause the carriage 10 to rotate leftward in place, a user is pushing the first grip portion 33a while pulling the second grip portion 33b. In this case, the first sensor 14A facing the first grip portion 33a is contracted, and thus the first wheel 23A is driven to travel forward by the first driving device 25A. On the other hand, the second sensor 14B facing the second grip portion 33b is expanded, and thus the second wheel 23B is driven to travel rearward by the second driving device 25B. As a result, the carriage 10 is assisted in rotating leftward in place.

In a case where a user intends to cause the carriage 10 to swivel to the right, the user pushes the first grip portion 33a on the right rear side of the carriage 10 with a decreased force and the second grip portion 33b on the left rear side of the carriage 10 with an increased force. At this time, a driving force outputted from the first driving device 25A based on a deformation amount of the first sensor 14A decreases, and a driving force outputted from the second driving device 25B based on a deformation amount of the second sensor 14B increases. As a result, a driving force outputted from the driving device 25 also acts to cause the carriage 10 to swivel to the right.

Furthermore, in a state shown in FIG. 5d, in an attempt to cause the carriage 10 to rotate rightward in place, a user is pulling the first grip portion 33a while pushing the second grip portion 33b. In this case, the first sensor 14A facing the first grip portion 33a is expanded, and thus the first wheel 23A is driven to travel rearward by the first driving device 25A, and the second sensor 14B facing the second grip portion 33b is contracted, and thus the second wheel 23B is driven to travel forward by the second driving device 25B. As a result, the carriage 10 is assisted in rotating rightward in place.

In a similar manner to a case of causing the carriage 10 to swivel while traveling forward, it is also possible to supply an assistance force for causing the carriage 10 to swivel while traveling rearward.

In the first example thus described, the operation handle 30 has the handle member 31 extending out from the carriage body 20 and the operation grip member 32 supported to the handle member 31. The operation grip member 32 includes the first grip portion 33a and the second grip portion 33b spaced apart from each other in the width direction da of the carriage body 20 and each grasped by a user. The sensor 14 includes the first sensor 14A for detecting a movement of the first grip portion 33a relative to the handle member 31 and the second sensor 14B for detecting a movement of the second grip portion 33b relative to the handle member 31. The driving device 25 includes the first driving device 25A and the second driving device 25B, and the plurality of wheels 23 include the first wheel 23A and the second wheel 23B spaced apart from each other in the width direction da of the carriage 10. The first driving device 25A outputs a driving force based on a result of measurement by the first sensor 14A to the first wheel 23A, and the second driving device 25B outputs a driving force based on a result of measurement by the second sensor 14B to the second wheel 23B.

According to the carriage 10 described above, a driving force supplied to the first wheel 23A is adjusted based on a force applied to the first grip portion 33a, and a driving force supplied to the second wheel 23B is adjusted based on a force applied to the second grip portion 33b. That is, it is possible to supply the carriage 10 with not only an assistance force for causing the carriage 10 to travel forward or rearward but also an assistance force for causing the carriage 10 to swivel in a desired direction, and it even becomes possible to adjust a swiveling radius. In addition, simply by handling the carriage 10 in a similar manner to a conventional carriage, a user can adjust even a magnitude of an assistance force and is also not required to release his/her hand from the operation handle 30 in order to operate a switch or the like. Moreover, an unwanted output of a driving force is suppressed, so that, for example, useless consumption of a battery can be avoided. That is, energy saving can be achieved.

Various modifications can be made to the carriage 10 described above as the first example. For example, the operation grip member 32 may be divided into a first operation grip member including the first grip portion 33a and a second operation grip member including the second grip portion 33b.

### Second Example

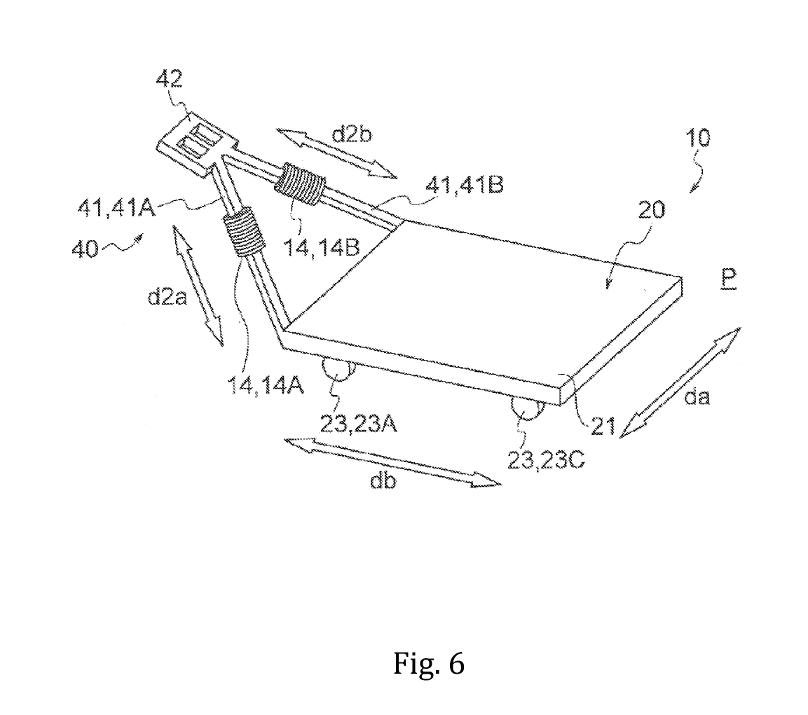

With reference to FIG. 6 to FIGS. 8a to 8d, a description is given of a second specific example of the carriage 10. A carriage 10 described as the second example is different in configuration of an operation handle from the above-mentioned carriage 10 of the first example and can be configured the same way as the carriage 10 of the first example in terms of other respects. Thus, the following mainly gives a description related to an operation handle 40 and does not repeat the same descriptions as in the first example.

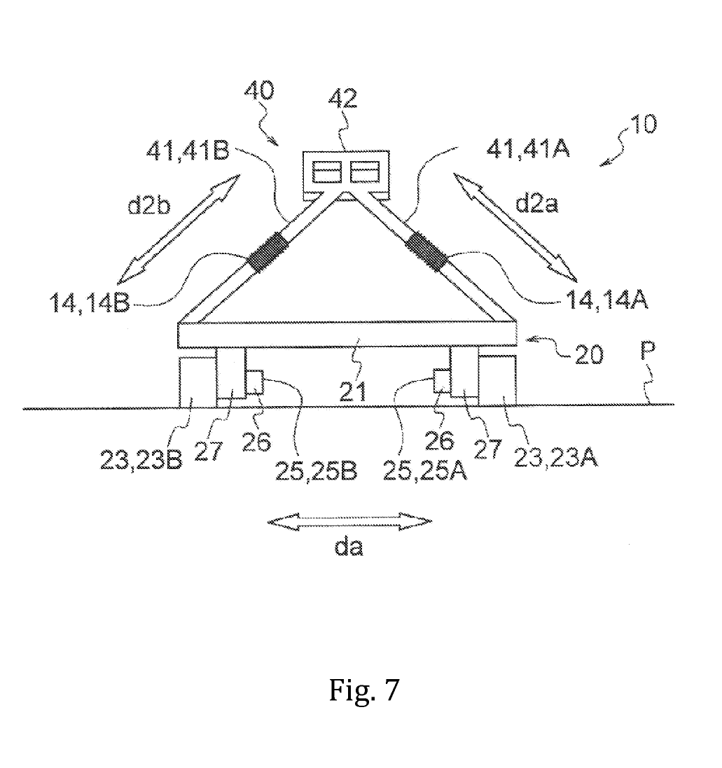

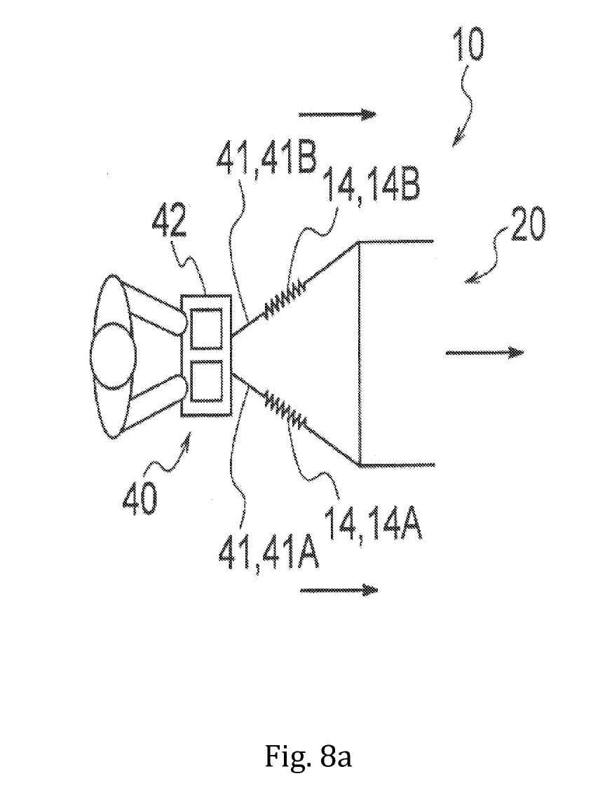

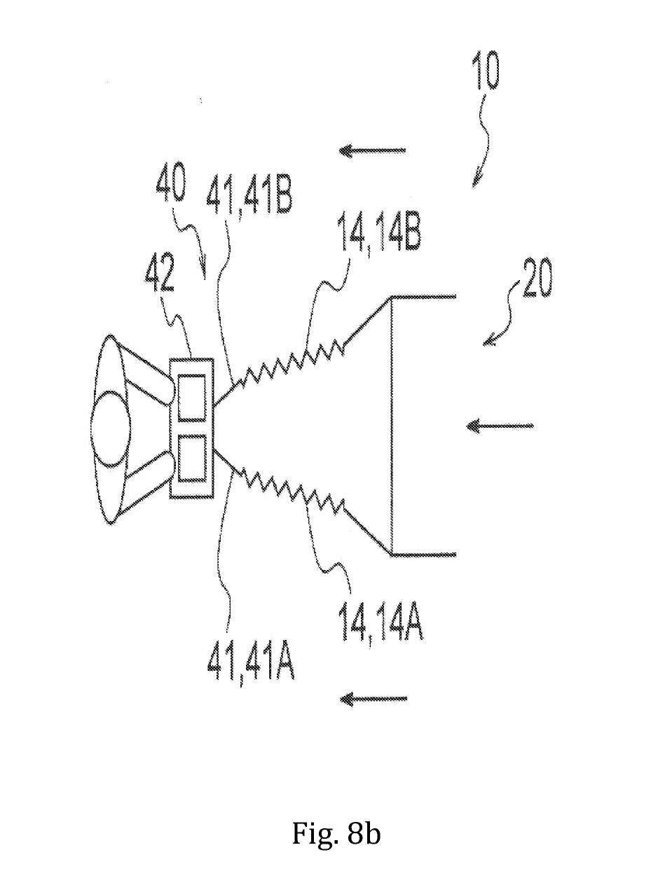

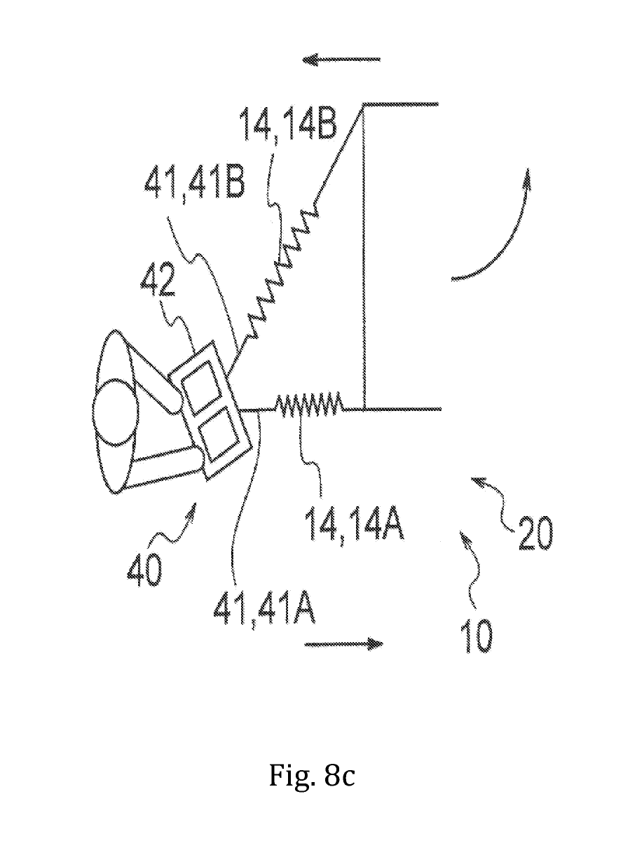

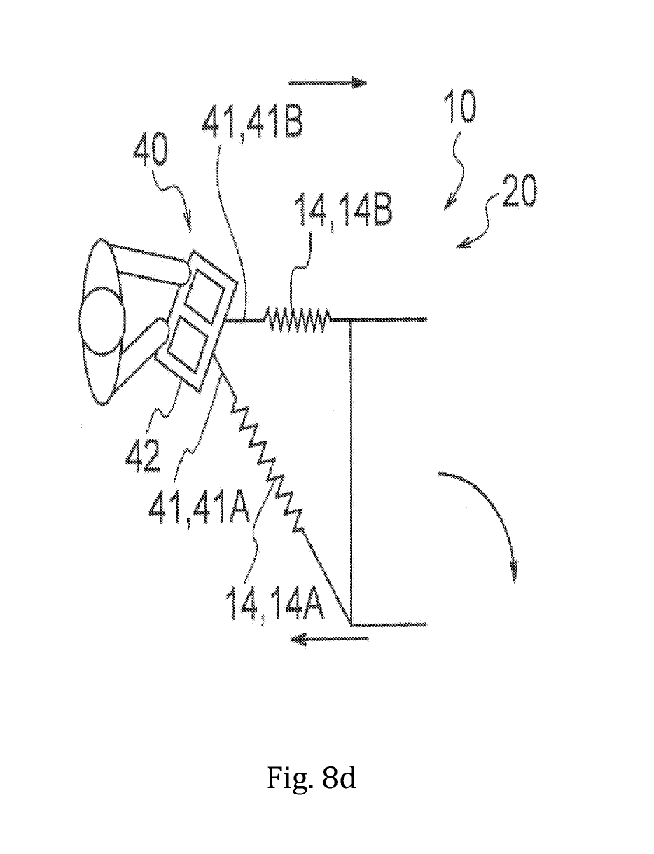

As shown in FIG. 6 and FIG. 7, in the second example of the carriage 10, the operation handle 40 has a first handle member 41A and a second handle member 41B extending upward from a carriage body 20 obliquely in a front-rear direction of the carriage 10 and an operation grip member 42 connected to the first handle member 41A and the second handle member 41B at a position spaced from the carriage body 20. The first handle member 41A and the second handle member 41B are spaced apart from each other in a width direction da of the carriage 10. The first handle member 41A and the second handle member 41B extend out rearward and upward from the carriage body 20. Furthermore, the first handle member 41A and the second handle member 41B are each formed as a rod-like member and have longitudinal directions d2a and d2b, respectively. A distance between the first handle member 41A and the second handle member 41B in the carriage width direction da decreases with increasing distance from the carriage body 20. As shown in FIG. 8a to FIG. 8d, the operation grip member 42 is a portion grasped by a user when operating the carriage 10.

In the second example, a sensor 14 includes a first sensor 14A and a second sensor 14B. The first sensor 14A and the second sensor 14B are spaced apart from each other in the carriage width direction da. The first sensor 14A measures information related to a force applied in the longitudinal direction d2a of the first handle member 41A. The second sensor 14B measures information related to a force applied in the longitudinal direction d2b of the second handle member 41B. As a specific configuration, the first sensor 14A and the second sensor 14B can be formed of a slide-type switch as already described with reference to FIG. 4. That is, the sensor 14 included in the carriage 10 of the second example is configured to be expandable and contractible in an axial direction (a longitudinal direction) thereof and thus can sense the amount of load along the axial direction based on an expansion amount or a contraction amount. As shown in FIG. 6 and FIG. 7, the first sensor 14A is built in the first handle member 41A, and the axial direction of the first sensor 14A matches the longitudinal direction d2a of the first handle member 41A. The second sensor 14B is built in the second handle member 41B, and the axial direction of the second sensor 14B matches the longitudinal direction d2b of the second handle member 41B.

In the carriage 10 of the second example, the carriage body 20 including a wheel 23 and a driving device 25 have configurations similar to those in the first example. Further, a first driving device 25A outputs a driving force based on a result of measurement by the first sensor 14A to a first wheel 23A. A second driving device 25B outputs a driving force based on a result of measurement by the second sensor 14B to a second wheel 23B.

Similarly to the above-mentioned carriage 10 of the first example, the carriage 10 of the second example configured as above can also supply a driving force for assisting the carriage 10 in traveling. Specifically, as shown in FIG. 8a, in a case where a user grasping the operation grip member 42 pushes the carriage 10, the sensors 14A and 14B are contracted, and the driving devices 25A and 25B supply a driving force for causing the carriage 10 to travel forward to the wheels 23A and 23B, respectively. As shown in FIG. 8b, in a case where a user grasping the operation grip member 42 pulls the carriage 10, the sensors 14A and 14B are expanded, and the driving devices 25A and 25B supply a driving force for causing the carriage 10 to travel rearward to the wheels 23A and 23B, respectively.

Furthermore, as shown in FIG. 8c, in a case where a user pushes the operation grip member 42 to the right, the first sensor 14A is contracted to a relatively large degree, and the second sensor 14B is contracted or expanded to a relatively small degree. Consequently, the first driving device 25A supplies a relatively large driving force for causing forward travel to the first wheel 23A, and the second driving device 25B supplies a relatively small driving force for causing forward travel or for causing rearward travel to the second wheel 23B. As a result, a driving force for causing the carriage 10 to swivel to the left is supplied. On the other hand, as shown in FIG. 8d, in a case where a user pushes the operation grip member 42 to the left, the sensors 14A and 14B are deformed in such a manner as to be left-right reversed from a state shown in FIG. 8c, so that respective driving forces supplied to the wheels 23A and 23B are also left-right reversed from the state shown in FIG. 8c. As a result, a driving force for causing the carriage 10 to swivel to the right is supplied. Similarly, it is also possible to supply an assistance force for causing the carriage 10 to swivel while traveling rearward.

In the second example thus described, the operation handle 40 includes the first handle member 41A and the second handle member 41B extending upward from the carriage body 20 obliquely in a front-rear direction db of the carriage body 20 and the operation grip member 42 connected to the first handle member 41A and the second handle member 41B and grasped by a user at a position spaced from the carriage body 20. The first handle member 41A and the second handle member 41B are spaced apart from each other in the width direction da of the carriage 10. The sensor 14 includes the first sensor 14A for measuring information related to a force applied in the longitudinal direction d2a of the first handle member 41A and the second sensor 14B for measuring information related to a force applied in the longitudinal direction d2b of the second handle member 41B. The driving device 25 includes the first driving device 25A and the second driving device 25B, and the plurality of wheels 23 include the first wheel 23A and the second wheel 23B spaced apart from each other in the width direction da of the carriage 10. The first driving device 25A outputs a driving force based on a result of measurement by the first sensor 14A to the first wheel 23A, and the second driving device 25B outputs a driving force based on a result of measurement by the second sensor 14B to the second wheel 23B.

According to the carriage 10 described above, a driving force supplied to the first wheel 23A is adjusted based on a force applied from the operation grip member 42 to the first handle member 41A, and a driving force supplied to the second wheel 23B is adjusted based on a force applied from the operation grip member 42 to the second handle member 41B. That is, it is possible to supply the carriage 10 with not only an assistance force for causing the carriage 10 to travel forward or rearward but also an assistance force for causing the carriage 10 to swivel in a desired direction, and it even becomes possible to adjust a swiveling radius. In addition, simply by handling the carriage 10 in a similar manner to a conventional carriage, a user can adjust even a magnitude of an assistance force and is also not required to release his/her hand from the operation handle 40 in order to operate a switch or the like. Moreover, an unwanted output of a driving force is suppressed, so that, for example, useless consumption of a battery can be avoided. That is, energy saving can be achieved.

### Third Example

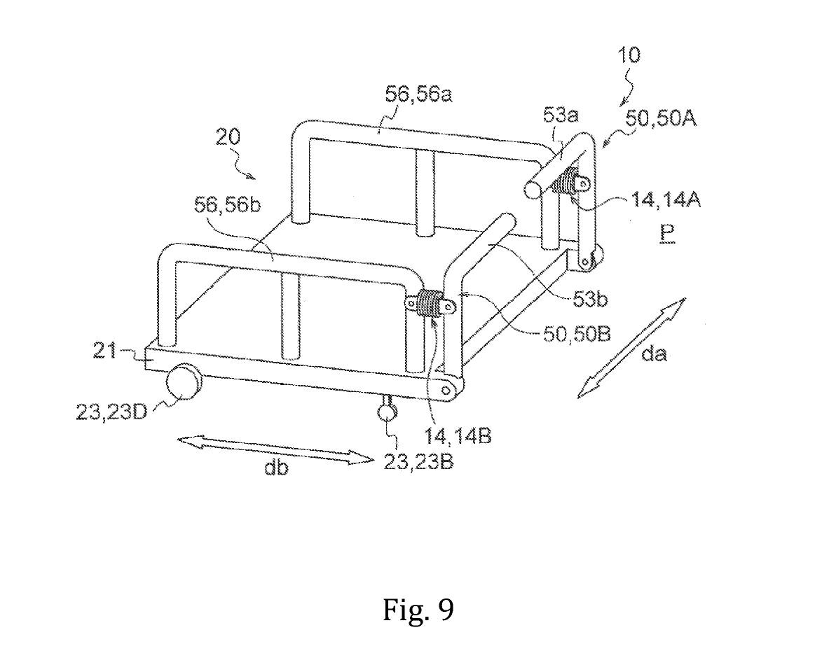

With reference to FIG. 9 to FIG. 11, a description is given of a third specific example of the carriage 10. A carriage 10 described as the third example is different from the above-mentioned carriage 10 of each of the first example and the second example mainly in that an operation handle 50 is swingably provided and can be configured the same way as the carriage 10 of each of the first example and the second example in terms of other respects. Thus, the following mainly gives a description related to the operation handle 50 and does not repeat the same descriptions as in the first or second example.

As shown in FIG. 9 to FIG. 11, in the third example of the carriage 10, the operation handle 50 extending upward from a carriage body 20 is connected to the carriage body 20 so as to be swingable with respect to the carriage body 20. In an example shown, the operation handle 50 is swingably mounted, at a lower end thereof, to a loading platform 21 of the carriage body 20. The carriage 10 has a frame member 56 secured to the loading platform 21 of the carriage body 20. The frame member 56 functions as a frame component for preventing a load Z from falling from the loading platform 21. Further, a sensor 14 joins the operation handle 50 to the frame member 56. In the third example, the sensor 14 detects a swing movement of the operation handle 50 extending upward from the carriage body 20 and thus can evaluate a force applied to the operation handle 50.

The example shown will be more specifically described below. The operation handle 50 includes a first operation handle 50A including a first grip portion 53a and a second operation handle SOB including a second grip portion 53b. The carriage 10 is provided with a first frame member 56a disposed on the right and a second frame member 56b disposed on the left. The first frame member 56a and the second frame member 56b are spaced apart from each other in a carriage width direction da. Further, the sensor 14 includes a first sensor 14A for detecting a swing movement of a part of the operation handle 50, the part including the first grip portion 53a, and a second sensor 14B for detecting a swing movement of another part of the operation handle 50, the another part including the second grip portion 53b.

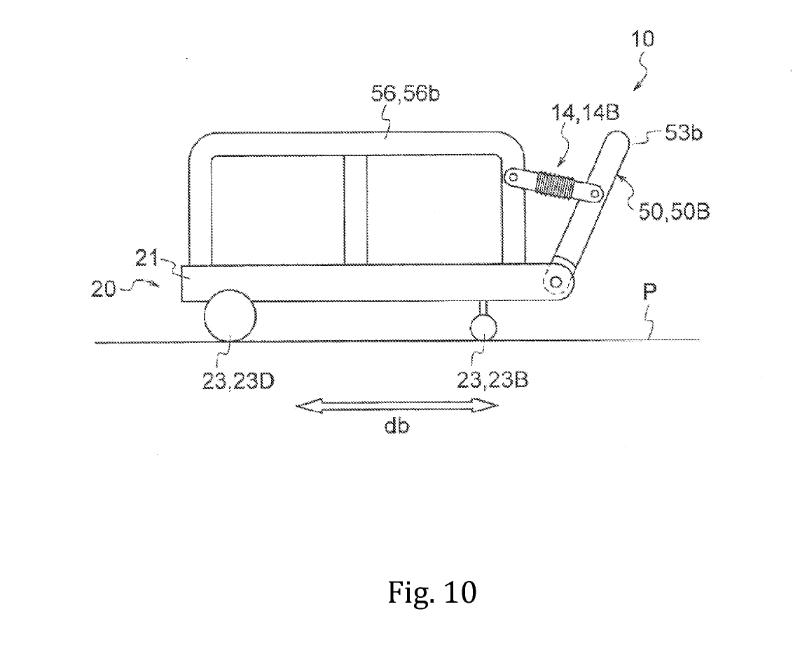

As a specific configuration, the first sensor 14A and the second sensor 14B can be formed of a slide-type switch as already described with reference to FIG. 4. That is, the sensor 14 included in the carriage 10 of the third example is configured to be expandable and contractible in an axial direction (a longitudinal direction) thereof and thus can sense the amount of load along the axial direction based on an expansion amount or a contraction amount. As shown in FIG. 9 and FIG. 10, the first sensor 14A joins the first operation handle 50A to the first frame member 56a. One end of the first sensor 14A is swingably connected to the first operation handle 50A, and the other end of the first sensor 14A is swingably connected to the first frame member 56a. The second sensor 14B joins the second operation handle SOB to the second frame member 56b. One end of the second sensor 14B is swingably connected to the second operation handle SOB, and the other end of the second sensor 14B is swingably connected to the second frame member 56b. Each of the frame members 56a and 56b is formed in a fence shape with no limitation thereto and may be formed in, for example, a rod shape.

In the carriage 10 of the third example, a wheel 23 and a driving device 25 have configurations similar to those in the first or second example. Further, a first driving device 25A outputs a driving force based on a result of measurement by the first sensor 14A to a first wheel 23A. A second driving device 25B outputs a driving force based on a result of measurement by the second sensor 14B to a second wheel 23B.

Also in the carriage 10 of the third example configured as above, in a case where a user grasping the operation handle 50 pushes the carriage 10, the sensor 14 is contracted between the operation handle 50 and the frame member 56. At this time, the driving device 25 supplies the wheel 23 with a driving force for causing the carriage 10 to travel forward. On the other hand, in a case where a user pulls the carriage 10, the sensor 14 is expanded between the operation handle 50 and the frame member 56. At this time, the driving device 25 supplies the wheel 23 with a driving force for causing the carriage 10 to travel rearward.

Furthermore, in a similar manner to the earlier description with reference to FIGS. 5a to 5d and FIGS. 8a to 8d, a force applied to the first grip portion 53a and a force applied to the second grip portion 53b are made to vary, and thus a driving force for causing the carriage 10 to swivel can be supplied. Specifically, when the first grip portion 53a disposed on the right in the carriage width direction da is pushed forward with increased strength, the first sensor 14A is contracted to a relatively large degree, and thus the first driving device 25A supplies a relatively large forward travel driving force to the first wheel 23A disposed on the right. As a result, the carriage 10 can be caused to swivel to the left. On the other hand, when the second grip portion 53b disposed on the left in the carriage width direction da is pushed forward with increased strength, the second sensor 14B is contracted to a relatively large degree, and thus the second driving device 25B supplies a relatively large forward travel driving force to the second wheel 23B disposed on the left. As a result, the carriage 10 can be caused to swivel to the right. Similarly, it is also possible to supply an assistance force for causing the carriage 10 to swivel while traveling rearward.

In the third example thus described, the sensor 14 is configured to detect a swing movement of the operation handle 50 extending upward from the carriage body 20. Thus, by utilizing the principle of leverage, a large force can be outputted to the sensor 14 through a swing movement of the operation handle 50. By this configuration, a force applied to the operation handle 50 can be detected with high accuracy.

Furthermore, in the third example, the operation handle 50 is configured to be swingable with respect to the carriage body 20 and includes the first grip portion 53a and the second grip portion 53b spaced apart from each other in the width direction da of the carriage 10 and each grasped by a user. The sensor 14 includes the first sensor 14A for detecting a swing movement of a part of the operation handle 50, the part including the first grip portion 53a, and the second sensor 14B for detecting a swing movement of another part of the operation handle 50, the another part including the second grip portion 53b. The driving device 25 includes the first driving device 25A and the second driving device 25B, and the plurality of wheels 23 include the first wheel 23A and the second wheel 23B spaced apart from each other in the width direction da of the carriage 10. The first driving device 25A outputs a driving force based on a result of measurement by the first sensor 14A to the first wheel 23A, and the second driving device 25B outputs a driving force based on a result of measurement by the second sensor 14B to the second wheel 23B.

According to the carriage 10 described above, a driving force supplied to the first wheel 23A is adjusted based on a force applied to the first grip portion 53a, and a driving force supplied to the second wheel 23B is adjusted based on a force applied to the second grip portion 53b. That is, it is possible to supply the carriage 10 with not only an assistance force for causing the carriage 10 to travel forward or rearward but also an assistance force for causing the carriage 10 to swivel in a desired direction, and it even becomes possible to adjust a swiveling radius. In addition, simply by handling the carriage 10 in a similar manner to a conventional carriage, a user can adjust even a magnitude of an assistance force and is also not required to release his/her hand from the operation handle 50 in order to operate a switch or the like. Moreover, an unwanted output of a driving force is suppressed, so that, for example, useless consumption of a battery can be avoided. That is, energy saving can be achieved.

Moreover, in the third example, the operation handle 50 includes the first operation handle 50A including the first grip portion 53a and the second operation handle SOB including the second grip portion 53b. The first operation handle 50A and the second operation handle SOB can swing independently of each other with respect to the carriage body 20. Consequently, a force applied to the first grip portion 53a can be evaluated with high accuracy by the first sensor 14A, and a force applied to the second grip portion 53b can be evaluated with high accuracy by the second sensor 14B. A configuration, however, may also be adopted in which, unlike the example shown, the first grip portion 53a and the second grip portion 53b are included in a single-unit operation handle 50.

### Fourth Example

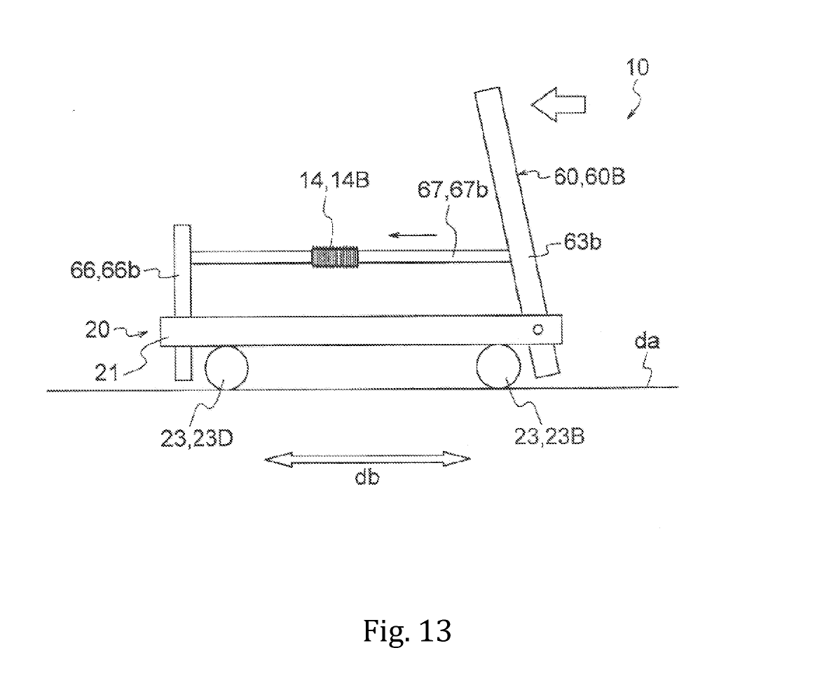

Next, with reference to FIG. 12 and FIG. 13, a description is given of a fourth specific example of the carriage 10. Also in a carriage 10 described as the fourth example, similarly to the third example, a sensor 14 is configured to detect a swing movement of an operation handle 60 extending upward from a carriage body 20. The fourth example, however, is different in configurations of the operation handle 60, the sensor 14, and a frame member 66 from the third example and can be configured the same way as the carriage 10 of the third example in terms of other respects. Thus, the following mainly gives a description related to the operation handle 60, the sensor 14, and the frame member 66 and does not repeat the same descriptions as in the first to third examples.

As shown in FIG. 12 and FIG. 13, in the fourth example of the carriage 10, the operation handle 60 extending upward from a carriage body 20 is connected to the carriage body 20 so as to be swingable with respect to the carriage body 20. In an example shown, the operation handle 60 is swingably mounted, at a lower end thereof, to a loading platform 21 of the carriage body 20. The carriage 10 has the frame member 66 secured to the loading platform 21 of the carriage body 20. The frame member 66 functions as a frame component for preventing a load Z from falling from the loading platform 21. A joint member 67 for joining the frame member 66 to the operation handle 60 is provided between the frame member 66 and the operation handle 60. The sensor 14 is built in the joint member 67 and measures information related to a force applied in a longitudinal direction of the joint member 67.

In the example shown, the operation handle 60 has a first operation handle 60A and a second operation handle 60B each being swingable with respect to the carriage body 20 and spaced apart from each other in a width direction da of the carriage 10. The first operation handle 60A and the second operation handle 60B are each formed as a rod-like member. The first operation handle 60A and the second operation handle 60B are disposed parallel to each other and extend in a direction substantially perpendicular to a travel surface P. An upper part of the first operation handle 60A constitutes a first grip portion 63a to be grasped by a user, and an upper part of the second operation handle 60B constitutes a second grip portion 63b to be grasped by the user. The first operation handle 60A and the second operation handle 60B thus configured also function as a frame component for preventing the load Z from falling from the loading platform 21. Furthermore, the first operation handle 60A and the second operation handle 60B thus configured are useful in that they allow an elongated load Z loaded on the loading platform 21 to extend further between the first operation handle 60A and the second operation handle 60B.

The frame member 66 includes a first frame member 66a and a second frame member 66b each extending upward from the carriage body 20 and spaced apart from each other in the width direction da of the carriage 10. The first frame member 66a and the second frame member 66b are disposed parallel to each other and extend in a direction substantially perpendicular to the travel surface P. The first frame member 66a and the second frame member 66b thus configured also function as a frame component for preventing the load Z from falling from the loading platform 21. Furthermore, the first frame member 66a and the second frame member 66b thus configured are useful in that they allow an elongated load Z loaded on the loading platform 21 to extend further between the first frame member 66a and the second frame member 66b.

The joint member 67 has a first joint member 67a joining the first frame member 66a to the first operation handle 60A and a second joint member 67b joining the second frame member 66b to the second operation handle 60B. The first joint member 67a and the second joint member 67b are disposed parallel to each other and extend substantially parallel to a front-rear direction db of the carriage 10. The first joint member 67a and the second joint member 67b thus configured also function as a frame component for preventing the load Z from falling from the loading platform 21.

In the fourth example, the sensor 14 includes a first sensor 14A and a second sensor 14B. The first sensor 14A and the second sensor 14B are spaced apart from each other in the carriage width direction da. The first sensor 14A measures information related to a force applied in a longitudinal direction d4a of the first joint member 67a. The second sensor 14B measures information related to a force applied in a longitudinal direction d4b of the second joint member 67b. As a specific configuration, the first sensor 14A and the second sensor 14B can be formed of a slide-type switch as already described with reference to FIG. 4. That is, the sensor 14 included in the carriage 10 of the fourth example is configured to be expandable and contractible in an axial direction (a longitudinal direction) thereof and thus can sense the amount of load along the axial direction based on an expansion amount or a contraction amount. As shown in FIG. 12 and FIG. 13, the first sensor 14A is built in the first joint member 67a, and the axial direction of the first sensor 14A matches the longitudinal direction d4a of the first joint member 67a. The second sensor 14B is built in the second joint member 67b, and the axial direction of the second sensor 14B matches the longitudinal direction d4b of the second joint member 67b.

In the carriage 10 of the fourth example, a wheel 23 and a driving device 25 can have configurations similar to those in any of the first to third examples. Further, a first driving device 25A outputs a driving force based on a result of measurement by the first sensor 14A to a first wheel 23A. A second driving device 25B outputs a driving force based on a result of measurement by the second sensor 14B to a second wheel 23B.

Also in the carriage 10 of the fourth example configured as above, in a case where a user grasping the operation handle 60 pushes the carriage 10, the sensor 14 is contracted between the operation handle 60 and the frame member 66. At this time, the driving device 25 supplies the wheel 23 with a driving force for causing the carriage 10 to travel forward. On the other hand, in a case where a user pulls the carriage 10, the sensor 14 is expanded between the operation handle 60 and the frame member 66. At this time, the driving device 25 supplies the wheel 23 with a driving force for causing the carriage 10 to travel rearward.

Furthermore, in a similar manner to the earlier description with reference to FIGS. 5a to 5d and FIGS. 8a to 8d, a force applied to the first grip portion 63a of the first operation handle 60A and a force applied to the second grip portion 63b of the second operation handle 60B are made to vary, and thus a driving force for causing the carriage 10 to swivel can be supplied. Specifically, when the first grip portion 63a of the first operation handle 60A disposed on the right in the carriage width direction da is pushed forward with increased strength, the first sensor 14A is contracted to a relatively large degree, and thus the first driving device 25A supplies a relatively large forward travel driving force to the first wheel 23A disposed on the right. As a result, the carriage 10 can be caused to swivel to the left. On the other hand, when the second grip portion 63b of the second operation handle 60B disposed on the left in the carriage width direction da is pushed forward with increased strength, the second sensor 14B is contracted to a relatively large degree, and thus the second driving device 25B supplies a relatively large forward travel driving force to the second wheel 23B disposed on the left. As a result, the carriage 10 can be caused to swivel to the right. Similarly, it is also possible to supply an assistance force for causing the carriage 10 to swivel while traveling rearward.

In the fourth example thus described, the sensor 14 is configured to detect a swing movement of the operation handle 60 extending upward from the carriage body 20. Thus, by utilizing the principle of leverage, a large force can be outputted to the sensor 14 through a swing movement of the operation handle 60. By this configuration, a force applied to the operation handle 60 can be detected with high accuracy.

Furthermore, the carriage 10 of the fourth example has the first frame member 66a and the second frame member 66b each extending upward from the carriage body 20 and spaced apart from each other in the width direction da of the carriage 10. The operation handle 60 has the first operation handle 60A and the second operation handle 60B each being swingable with respect to the carriage body 20 and spaced apart from each other in the width direction da of the carriage 10. The first joint member 67a is provided to join the first frame member 66a to the first operation handle 60A, and the second joint member 67b is provided to join the second frame member 66b to the second operation handle 60B. The sensor 14 includes the first sensor 14A for measuring information related to a force applied in the longitudinal direction d4a of the first joint member 67a and the second sensor 14B for measuring information related to a force applied in the longitudinal direction d4b of the second joint member 67b. The driving device 25 includes the first driving device 25A and the second driving device 25B, and the plurality of wheels 23 include the first wheel 23A and the second wheel 23B spaced apart from each other in the width direction da of the carriage 10. The first driving device 25A outputs a driving force based on a result of measurement by the first sensor 14A to the first wheel 23A, and the second driving device 25B outputs a driving force based on a result of measurement by the second sensor 14B to the second wheel 23B.

According to the carriage 10 described above, a driving force supplied to the first wheel 23A is adjusted based on a force applied to the first operation handle 60A, and a driving force supplied to the second wheel 23B is adjusted based on a force applied to the second operation handle 60B. That is, it is possible to supply the carriage 10 with not only an assistance force for causing the carriage 10 to travel forward or rearward but also an assistance force for causing the carriage 10 to swivel in a desired direction, and it even becomes possible to adjust a swiveling radius. In addition, simply by handling the carriage 10 in a similar manner to a conventional carriage, a user can adjust even a magnitude of an assistance force and is also not required to release his/her hand from the operation handle 60 in order to operate a switch or the like. Moreover, an unwanted output of a driving force is suppressed, so that, for example, useless consumption of a battery can be avoided. That is, energy saving can be achieved.

Furthermore, a frame component for preventing the load Z from falling can be used as the operation handle 60. In this example, there is no need to provide a dedicated operation handle, and thus, the variously shaped load Z can be loaded on the loading platform 21. Furthermore, a plurality of loads Z can be loaded with less limitation on how they are loaded.

While the example shown illustrates a case where the sensor 14 and the joint member 67 are disposed on an upper side than the loading platform 21, there is no limitation thereto. For example, a configuration may be adopted in which the frame member 66 and the operation handle 60 extend to below the loading platform 21, and below the loading platform 21, the joint member 67 joins the frame member 66 to the operation handle 60. The joint member 67 is disposed below the loading platform 21, and thus it is possible to effectively reduce limitation on the shape of the load Z or how to load the load Z.

### Fifth Example

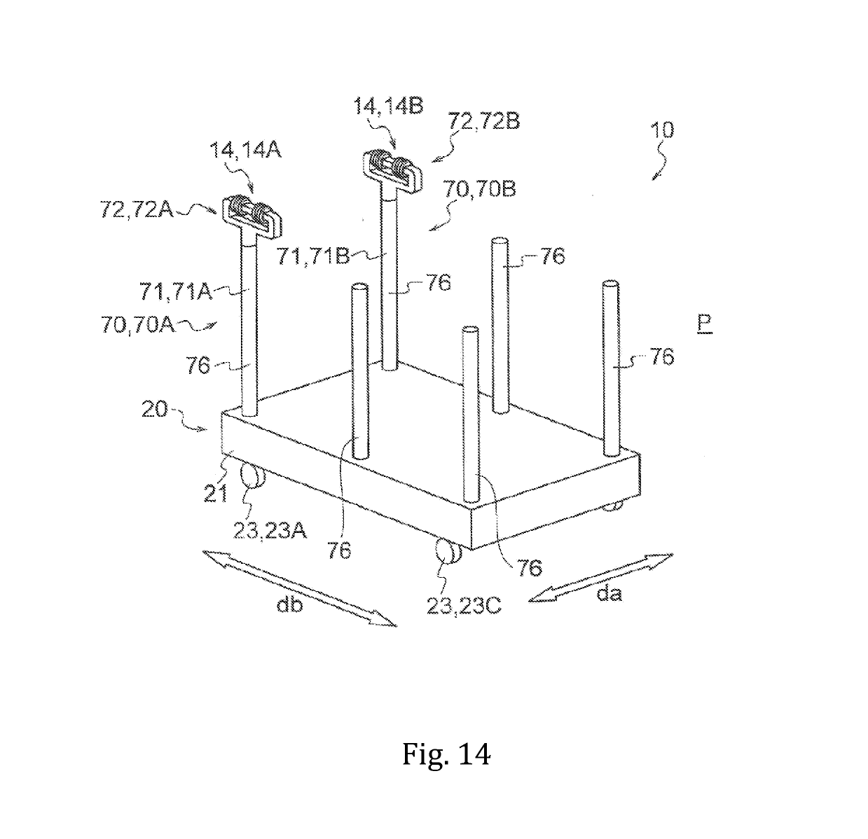

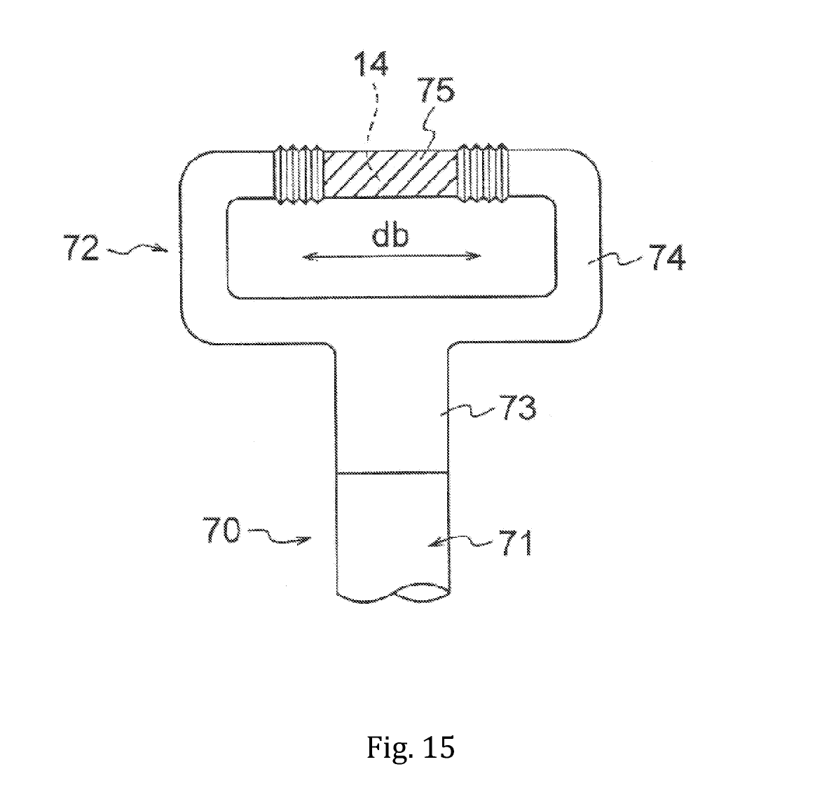

Next, with reference to FIG. 14 and FIG. 15, a description is given of a fifth specific example of the carriage 10. A carriage 10 described as the fifth example is different in configuration of an operation handle from the carriage 10 of each of the first to fourth examples and can be configured the same way as the carriage 10 of any of the first to fourth examples in terms of other respects. Thus, the following mainly gives a description related to an operation handle 70 and does not repeat the same descriptions as in the first to fourth examples.

As shown in FIG. 14, the carriage 10 has a frame member 76 extending upward from a carriage body 20. In an example shown, a plurality of frame members 76 are provided. The frame member 76 functions as a frame component for preventing a load Z from falling from a loading platform 21. More specifically, two sets of frame members 76 each composed of three frame members 76 disposed along a front-rear direction db of the carriage 10 are spaced apart from each other in a width direction da of the carriage 10. In the example shown, two frame members 76 each being a rearmost one of each of the two sets of frame members 76 constitute an operation handle 70. That is, in the example shown in FIG. 14, the operation handle 70 has a first operation handle 70A and a second operation handle 70B spaced apart from each other in the carriage width direction da.

In the carriage 10 according to the fifth example, the operation handle 70 has a handle member 71 extending upward from the carriage body 20 and an operation input member 72 mounted to the handle member 71. A first operation handle 70A has a first handle member 71A and an operation input member 72A. A second operation handle 70B has a second handle member 71B and an operation input member 72B.

As shown in FIG. 15, the operation input member 72 is mounted to an upper end of the handle member 71. The operation input member 72 includes a securing portion 73 mounted to the handle member 71, a base portion 74 connected to the securing portion 73, and a grip portion 75 supported by the base portion 74. The grip portion 75 is configured to be movable in one direction relative to the base portion 74. In the example shown, the grip portion 75 is movable in the front-rear direction db with respect to the base portion 74. The grip portion 75 is retained at a reference position with respect to the base portion 74 and configured so that, when having moved forward in the front-rear direction db, the grip portion 75 is biased rearward toward the reference position, and when having moved rearward in the front-rear direction db, the grip portion 75 is biased forward toward the reference position.

In the fifth example, a sensor 14 includes a first sensor 14A and a second sensor 14B. The first sensor 14A is provided in the operation input member 72 of the first operation handle 70A and detects a movement of the grip portion 75 relative to the base portion 74. The second sensor 14B is provided in the operation input member 72 of the second operation handle 70B and detects a movement of the grip portion 75 relative to the base portion 74. The sensors 14A and 14B monitor a movement of the grip portion 75 so as to measure information related to a force applied to the grip portion 75.

As a specific configuration, the first sensor 14A and the second sensor 14B can be formed of a slide-type switch as already described with reference to FIG. 4. That is, the sensor 14 included in the carriage 10 of the fifth example is configured to be expandable and contractible in an axial direction (a longitudinal direction) thereof and thus can sense the amount of load along the axial direction based on an expansion amount or a contraction amount. As one example, a first component 17 of the sensor 14 is secured to the grip portion 75, and a second component 18 of the sensor 14 is secured to the base portion 74. According to this application example, the grip portion 75 moves relative to the base portion 74, causing the sensor 14 to be expanded or contracted, and thus a force applied to the grip portion 75 can be measured.

In the carriage 10 of the fifth example, a wheel 23 and a driving device 25 can have configurations similar to those in any of the first to fourth examples. Further, a first driving device 25A outputs a driving force based on a result of measurement by the first sensor 14A to a first wheel 23A. A second driving device 25B outputs a driving force based on a result of measurement by the second sensor 14B to a second wheel 23B.

Also in the carriage 10 of the fifth example configured as above, in a case where a user grasps the grip portion 75 of the operation handle 70 and pushes the carriage 10, the sensor 14 is contracted or expanded between the grip portion 75 and the base portion 74 in the operation input member 72. At this time, the driving device 25 supplies the wheel 23 with a driving force for causing the carriage 10 to travel forward. On the other hand, in a case where a user grasps the grip portion 75 of the operation handle 70 and pulls the carriage 10, the sensor 14 is expanded or contracted. At this time, the driving device 25 supplies the wheel 23 with a driving force for causing the carriage 10 to travel rearward.

Furthermore, in a similar manner to the earlier description with reference to FIGS. 5a to 5d and FIGS. 8a to 8d, a force applied to the grip portion 75 of the first operation handle 70A and a force applied to the grip portion 75 of the second operation handle 70B are made to vary, and thus a driving force for causing the carriage 10 to swivel can be supplied. Specifically, when the grip portion 75 of the first operation handle 70A disposed on the right in the carriage width direction da is pushed forward with increased strength, the first sensor 14A is deformed to a relatively large degree, and thus the first driving device 25A supplies a relatively large driving force to the first wheel 23A disposed on the right. As a result, the carriage 10 can be caused to swivel to the left. On the other hand, when the grip portion 75 of the second operation handle 70B disposed on the left in the carriage width direction da is pushed forward with increased strength, the second sensor 14B is deformed to a relatively large degree, and thus the second driving device 25B supplies a relatively large forward travel driving force to the second wheel 23B disposed on the left. As a result, the carriage 10 can be caused to swivel to the right. Similarly, it is also possible to supply an assistance force for causing the carriage 10 to swivel while traveling rearward.

In the fifth example thus described, the operation handle 70 has the handle member 71 extending out from the carriage body 20 and the operation input member 72 provided on the handle member 71. The operation input member 72 includes the base portion 74 connected to the handle member 71 and the grip portion 75 movably retained to the base portion 74 and grasped by a user. The sensor 14 detects a movement of the grip portion 75 relative to the base portion 74. According to the fifth example described above, simply by handling the carriage 10 in a similar manner to a conventional carriage, a user can adjust even a magnitude of an assistance force and is also not required to release his/her hand from the operation handle 70 in order to operate a switch or the like. Moreover, an unwanted output of a driving force is suppressed, so that, for example, useless consumption of a battery can be avoided. That is, energy saving can be achieved.

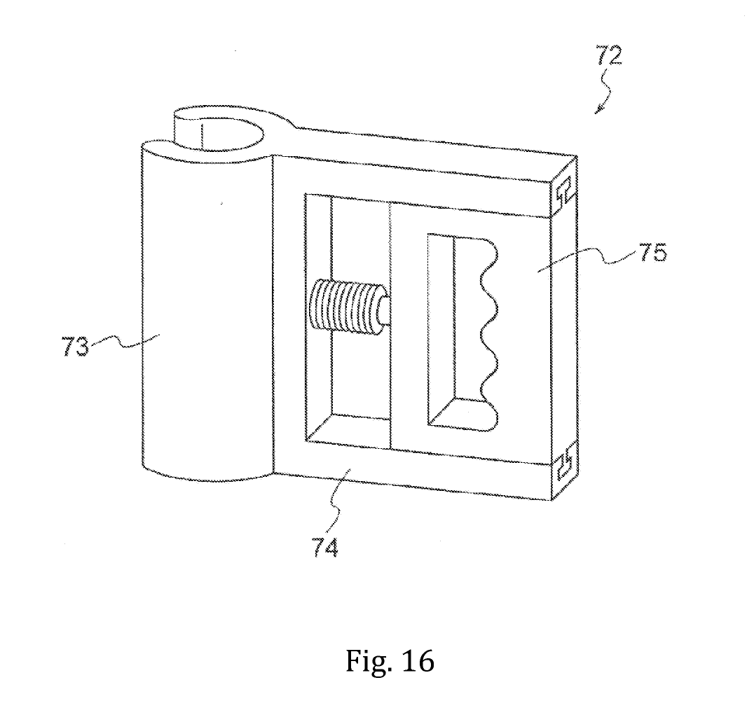

Various modifications can be made to the fifth example described above. For example, an operation input member 72 shown in FIG. 16 can also be used. The operation input member 72 shown in FIG. 16 includes a securing portion 73 mounted to the handle member 71, a base portion 74 connected to the securing portion 73, and a grip portion 75 supported by the base portion 74. The grip portion 75 extends in a vertical direction and is configured to be movable in the front-rear direction db with respect to the base portion 74. A sensor 14 is disposed between the base portion 74 and the grip portion 75 and is configured to detect a relative movement between the base portion 74 and the grip portion 75, thus being able to evaluate a force applied to the grip portion 75. The above-mentioned effect can be obtained also by the operation input member 72 shown in FIG. 16.

Furthermore, the operation input member 72 may be configured to be demountable from the handle member 71. For example, in the operation input member 72 shown in FIG. 16, the base portion 74 is formed in a clip shape. By this configuration, a mounting position of the operation input member 72 with respect to the frame member 76 (the handle member 71) can be adjusted. Furthermore, in the carriage 10 shown in FIG. 14, the first operation handle 70A and the second operation handle 70B may be mounted to two of the frame members 76 (the handle members 71), which are disposed on the right in the carriage width direction da, respectively. For example, one of the two of the frame members 76 (the handle members 71) is disposed on the right in the carriage width direction da and on a rearmost side in the front-rear direction db and the other of the two of the frame members 76 (the handle members 71) is disposed on the right in the carriage width direction da and in the middle in the front-rear direction db. According to these examples, for example, the operation input member 72 can be installed at a position suitable for operating the carriage 10 so as to correspond to the body shape of a user, the shape of the load Z, or the like. By this configuration, it becomes easier to apply a force to the carriage 10 via the operation handle 70 and thus can further improve operability of the carriage 10.

Moreover, a result of measurement by the sensor 14 provided in the operation input member 72 may be wirelessly transmitted to the control portion 12. In a case where the operation input member 72 is demountable from the handle member 71, by wirelessly transmitting acquired information, a position of the operation input member 72 can be adjusted without the need to consider wiring extending between the operation input member 72 and the control portion 12. This can further improve handling ease of the carriage 10.

In one embodiment described thus far while referring to some specific examples, the carriage 10 has the carriage body 20 having the loading platform 21 for bearing the load Z and the plurality of wheels 23 rotatably retained to the loading platform 21, the operation handle 30, 40, 50, 60, or 70 connected to the carriage body 20 and grasped by a user operating the carriage 10, the sensor 14 for measuring information related to a force applied to the operation handle 30, 40, 50, 60, or 70, and the driving device 25 for outputting a driving force based on a result of detection by the sensor 14 to any of the plurality of wheels 23. According to the carriage 10 described above, a driving force based on a force applied to the operation handle 30, 40, 50, 60, or 70 is outputted from the driving device 25 to a corresponding one of the wheels 23. That is, based on a force for operating the carriage 10 applied by a user, a driving force for causing the carriage 10 to achieve travel intended by the user is outputted. Thus, it becomes possible to significantly improve operability of the carriage 10 assisted in traveling by being supplied with a driving force.

Furthermore, in the foregoing one embodiment, the sensor 14 includes the first sensor 14A and the second sensor 14B, and the driving device 25 includes the first driving device 25A and the second driving device 25B. The plurality of wheels 23 include the first wheel 23A and the second wheel 23B spaced apart from each other in the width direction da of the carriage 10. The first driving device 25A outputs a driving force based on a result of measurement by the first sensor 14A to the first wheel 23A, and the second driving device 25B outputs a driving force based on a result of measurement by the second sensor 14B to the second wheel 23B. According to one embodiment described above, based on a result of measurement of a force applied to the operation handle 30, 40, 50, 60, or 70 by the first sensor 14A and the second sensor 14B, respective magnitudes and directions of driving forces outputted from the first driving device 25A and the second driving device 25B can be controlled independently of each other. By this configuration, an assistance force for deflecting a travel direction of the carriage 10 can be supplied to the carriage 10, and the degree of deflection can also be controlled. In addition, such swiveling control is achieved based on a force applied by a user to the operation handle 30, 40, 50, 60, or 70, and thus it is possible to significantly improve operability of the carriage 10 assisted in traveling by being supplied with a driving force and also to significantly improve freedom of traveling.

Moreover, in the foregoing one embodiment, the sensor 14 is expanded or contracted in one direction, thus being able to highly accurately evaluate a magnitude of a force applied to the operation handle 30, 40, 50, 60, or 70, and the sensor 14 itself is simply configured and less costly. Moreover, it is also extremely easy to perform, for example, arithmetic processing on a result of measurement. By this configuration, it also becomes possible to effectively avoid complication and a size increase of a carriage.

Various modifications can be made to the foregoing embodiment.

What is claimed is:

1. A carriage, comprising:
a carriage body having:
a loading platform for bearing a load; and
a plurality of wheels rotatably retained to the loading platform;
an operation handle connected to the carriage body and grasped by a user;
a sensor for measuring information related to a force applied to the operation handle; and
a driving device for outputting a driving force based on a result of detection by the sensor to any of the plurality of wheels.

2. The carriage according to claim 1, wherein the operation handle has a handle member and an operation grip member, the handle member extending out from the carriage body, the operation grip member being supported to the handle member,
the operation grip member includes a first grip portion and a second grip portion spaced apart from each other in a width direction of the carriage and each grasped by a user,
the sensor includes a first sensor and a second sensor, the first sensor detecting a movement of the first grip portion relative to the handle member, the second sensor detecting a movement of the second grip portion relative to the handle member,
the driving device includes a first driving device and a second driving device,
the plurality of wheels include a first wheel and a second wheel spaced apart from each other in the width direction of the carriage,
the first driving device outputs a driving force based on a result of measurement by the first sensor to the first wheel, and
the second driving device outputs a driving force based on a result of measurement by the second sensor to the second wheel.

3. The carriage according to claim 1, wherein the operation handle includes a first handle member, a second handle member, and an operation grip member, the first handle member and the second handle member extending upward from the carriage body obliquely in a front-rear direction of the carriage, the operation grip member being connected to the first handle member and the second handle member and grasped by a user at a position spaced from the carriage body,
the first handle member and the second handle member are spaced apart from each other in a width direction of the carriage,
the sensor includes a first sensor and a second sensor, the first sensor measuring information related to a force applied in a longitudinal direction of the first handle member, the second sensor measuring information related to a force applied in a longitudinal direction of the second handle member,
the driving device includes a first driving device and a second driving device,
the plurality of wheels include a first wheel and a second wheel spaced apart from each other in the width direction of the carriage,
the first driving device outputs a driving force based on a result of measurement by the first sensor to the first wheel, and
the second driving device outputs a driving force based on a result of measurement by the second sensor to the second wheel.

4. The carriage according to claim 1, wherein the sensor detects a swing movement of the operation handle extending upward from the carriage body.

5. The carriage according to claim 1, wherein the operation handle is swingable with respect to the carriage body,
the operation handle includes a first grip portion and a second grip portion spaced apart from each other in a width direction of the carriage and each grasped by a user,
the sensor includes a first sensor and a second sensor, the first sensor detecting a swing movement of a part of the operation handle, the part including the first grip portion, the second sensor detecting a swing movement of another part of the operation handle, the another part including the second grip portion,
the driving device includes a first driving device and a second driving device,
the plurality of wheels include a first wheel and a second wheel spaced apart from each other in the width direction of the carriage,
the first driving device outputs a driving force based on a result of measurement by the first sensor to the first wheel, and
the second driving device outputs a driving force based on a result of measurement by the second sensor to the second wheel.

6. The carriage according to claim 1, further comprising:
a first frame member and a second frame member spaced apart from each other in a width direction of the carriage and each extending upward from the carriage body,
wherein the operation handle has a first operation handle and a second operation handle spaced apart from each other in the width direction of the carriage and each being swingable with respect to the carriage body,
a first joint member is provided to join the first frame member to the first operation handle, and a second joint member is provided to join the second frame member to the second operation handle,
the sensor includes a first sensor and a second sensor, the first sensor measuring information related to a force applied in a longitudinal direction of the first joint member, the second sensor measuring information related to a force applied in a longitudinal direction of the second joint member,
the driving device includes a first driving device and a second driving device,
the plurality of wheels include a first wheel and a second wheel spaced apart from each other in the width direction of the carriage,
the first driving device outputs a driving force based on a result of measurement by the first sensor to the first wheel, and
the second driving device outputs a driving force based on a result of measurement by the second sensor to the second wheel.

7. The carriage according to claim 1, wherein the operation handle has a handle member and an operation input member, the handle member extending out from the carriage body, the operation input member being provided on the handle member,
the operation input member includes a base portion and a grip portion, the base portion being connected to the handle member, the grip portion being movably retained to the base portion and grasped by a user, and
the sensor detects a movement of the grip portion relative to the base portion.

8. The carriage according to claim 7, wherein a position of the operation input member mounted on the handle member is changeable.
